(19) United States
(12) Patent Application Publication
(10) Pub. No.: US 2014/0359321 A1
(43) Pub. Date: Dec. 4, 2014

(54) PREVENTIVE APPARATUS AND METHOD FOR PROTECTING SERVER

(71) Applicant: HON HAI PRECISION INDUSTRY CO., LTD., New Taipei (TW)

(72) Inventors: CHAO-KE WEI, New Taipei (TW); YAO-TING CHANG, New Taipei (TW)

(73) Assignee: HON HAI PRECISION INDUSTRY CO., LTD., New Taipei (TW)

(21) Appl. No.: 14/290,895

(22) Filed: May 29, 2014

(30) Foreign Application Priority Data
May 29, 2013 (TW) 102118936

(51) Int. Cl. G06F 1/32

(52) U.S. Cl. CPC G06F 1/3209
USPC 713/310

(57) ABSTRACT

A preventive apparatus and a preventive method for preventing an automatic server shutdown are described. The preventive apparatus includes a power consumption determination unit and a controller. The power consumption determination unit compares the power consumption of the server with a preset power consumption value and determines whether the power consumption of the server has reached the preset power consumption value. If the power consumption of the server has reached or exceeded the preset power consumption value, the controller sends a command to the server to control the server to decrease the operating frequency of internal power device or component, to achieve a reduced power consumption in the server.

### CROSS-REFERENCE TO RELATED APPLICATIONS

This application claims priority to Taiwanese Patent Application No. 102118936 filed on May 29, 2013 in the Taiwan Intellectual Property Office, the contents of which are incorporated by reference herein.

### FIELD

The present disclosure relates to preventive apparatuses and methods and more particularly to an apparatus and method for avoiding automatic shutdown of a server.

### BACKGROUND

Servers play an important role in networks and are usually grouped together in a rack for easier management. The servers may be automatically shutdown for self-protection if high power is consumed, which will cause unexpectable damage to the servers.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a preventive apparatus applied to a server, according to an exemplary embodiment.

FIG. 2 is a flowchart of a preventive method applied to a server, according to an exemplary embodiment.

FIG. 3 is a block diagram of a preventive apparatus applied to a server, according to another exemplary embodiment.

FIG. 4 is a flowchart of a preventive method for a server, according to another exemplary embodiment.

FIG. 5 is a diagram of a frequency-rank table stored in a storage unit of the preventive apparatus of FIG. 3, according to another exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure is described in relation to a preventive apparatus and a preventive method applied to a server. The apparatus includes a power consumption determination unit and a controller. The power consumption determination unit compares the power consumption of the server with a preset power consumption value and determines whether the power consumption has reached or exceeded the preset power consumption value. If yes, the controller sends a command to the server to control the server to decrease the operating frequency of a particular device or component, to correspondingly decrease the power consumption of the server.

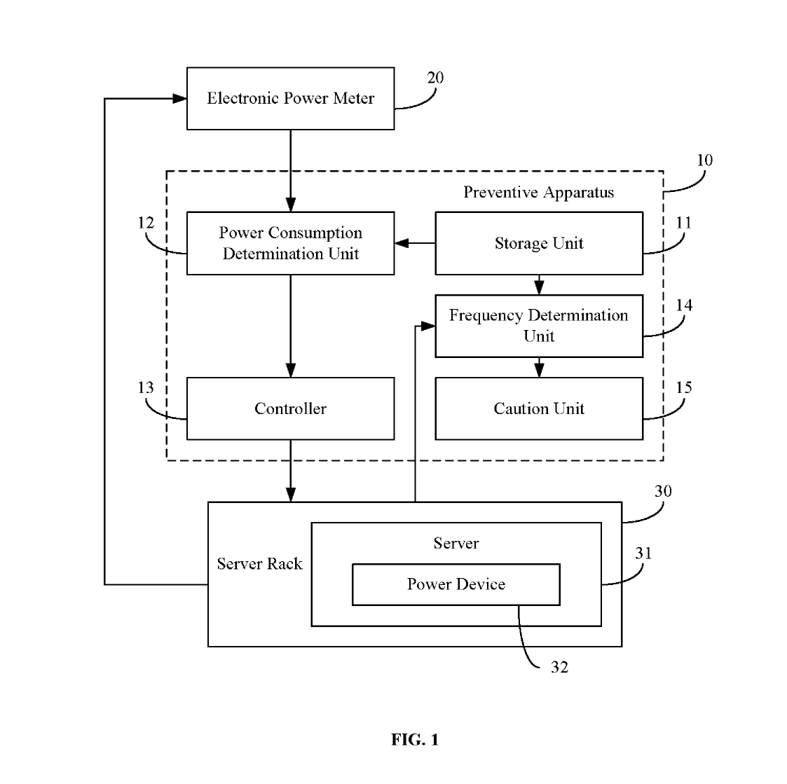

FIG. 1 illustrates a preventive apparatus 10 for protecting a server 31 according to an exemplary embodiment. The preventive apparatus 10 is electrically coupled to an electronic power meter 20 and a server rack 30. The electronic power meter 20 is electrically coupled to the server rack 30. The server 31 is accommodated in the server rack 30, and the server 31 can include one or more devices or components (power device 32). The power device 32 consumes power when the server 31 is working, the power device 32 can be a CPU or a memory bank. The preventive apparatus 10 can include a storage unit 11, a power consumption determination unit 12, a controller 13, a frequency determination unit 14 and a caution unit 15.

The storage unit 11 stores a preset power consumption value and a preset frequency value.

The power consumption determination unit 12 obtains the power consumption of the server 31 as it is read and detected by the electronic power meter 20. The power consumption determination unit 12 determines whether the obtained power consumption of the server 31 reaches or exceeds the preset power consumption value stored in the storage unit 11.

The controller 13 sends a command for decreasing the power consumption to the server 31 when the power consumption of the server 31 reaches or exceeds the preset power consumption value. In at least one embodiment, the controller 13 sends a command for decreasing the operating frequency of the power device 32 to the server 31.

The server 31 decreases the operating frequency of the power device 32 according to the command sent from the controller 13. In at least one embodiment, the server 31 decreases the operating frequency of the power device 32 by one rank. In the disclosure, decreasing the operating frequency by one rank decreases the operating frequency by one grade from current operating frequency. For example, if a frequency range of 0.5 GHz constitutes a rank, and the current operating frequency of a CPU is 3.3 GHz, decreasing the operating frequency of the CPU by one rank means that the operating frequency of the CPU is decreased to 2.8 GHz. If an operating frequency of 267 MHz constitutes a rank and the current operating frequency of a memory bank is 1600 MHz, decreasing the operating frequency of the memory bank by one rank means that the operating frequency of the memory bank is decreased to 1333 MHz. The power consumption of the server 31 decreases as the operating frequency of the power device 32 is lowered.

The frequency determination unit 14 obtains the operating frequency of the power device 32 after the server 31 has controlled the operating frequency of the power device 32 by decreasing it. The frequency determination unit 14 determines whether the operating frequency of the power device 32 is lower than the preset frequency value stored in the storage unit 11.

The caution unit 15 issues a caution message when the operating frequency of the power device 31, as received by the frequency determination unit 14, has been lowered to be equal to lower than the preset frequency value. In at least one embodiment, the caution unit 15 is a display panel, and the display panel shows a text message when the caution message is issued. In an alternative embodiment, the caution unit 15 can be a LED light or a loudspeaker. The LED light may shine or the loudspeaker make an audible sound when the caution message is issued.

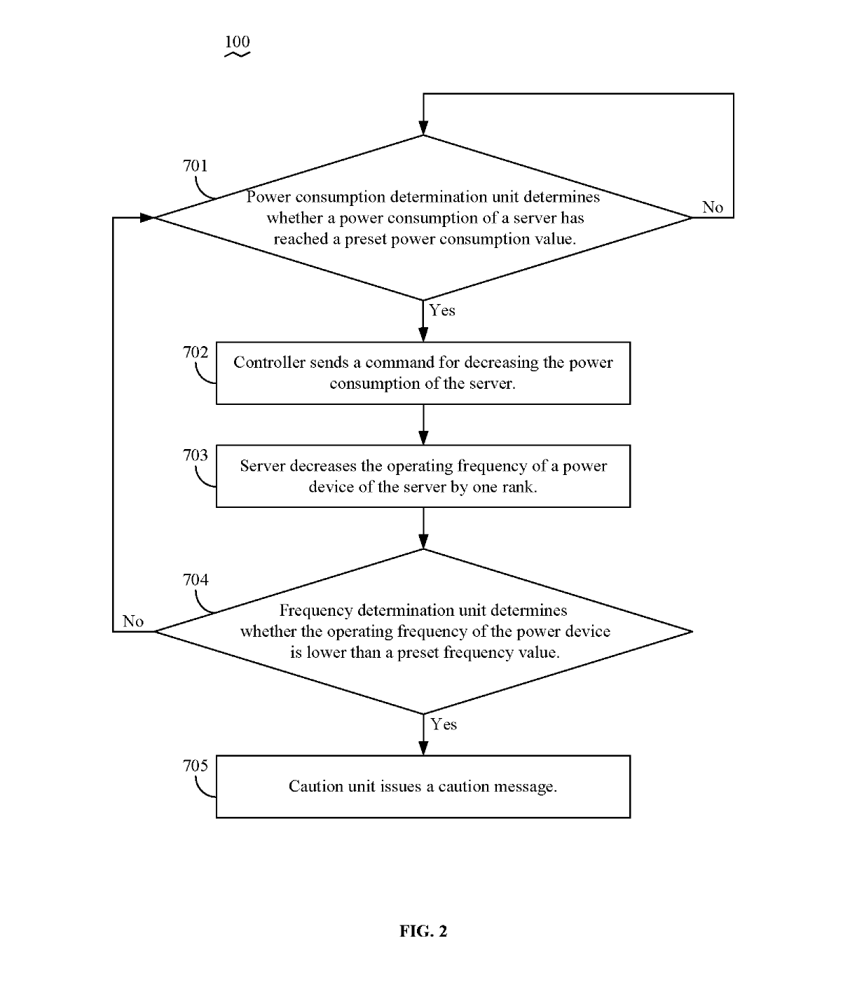

Referring to FIG. 2, a flowchart is presented in accordance with an example embodiment. The example method 100 is provided by way of example, as there are a variety of ways to carry out the method. The method 100 described below can be carried out using the configurations illustrated in FIG. 1 and various elements of these figures are referenced in explaining example method 100. Each block shown in FIG. 2 represents one or more processes, methods, or subroutines, carried out in the exemplary method 100. Additionally, the illustrated order of blocks is by example only and the order of the blocks can be changed. The exemplary method 100 can begin at block 701.

At block 701, a power consumption determination unit determines whether a power consumption value of a server has reached a preset power consumption value stored in a storage unit from power consumption signals received. If yes, the process goes to block 702; otherwise, if the power consumption value of the server is lower than the preset power consumption value, the process remains in block 701.

At block 702, a controller sends a command to the server to decrease the power consumption of the server.

At block 703, the server decreases by one rank the operating frequency of a power device of the server.

At block 704, a frequency determination unit obtains the operating frequency of the power device, and determines whether the operating frequency of the power device is lower than a preset frequency value stored in the storage unit. If yes, the process goes to block 705; otherwise, if the operating frequency of the power device is greater than the preset frequency value, the process returns to block 701.

At block 705, a caution unit issues a caution message.

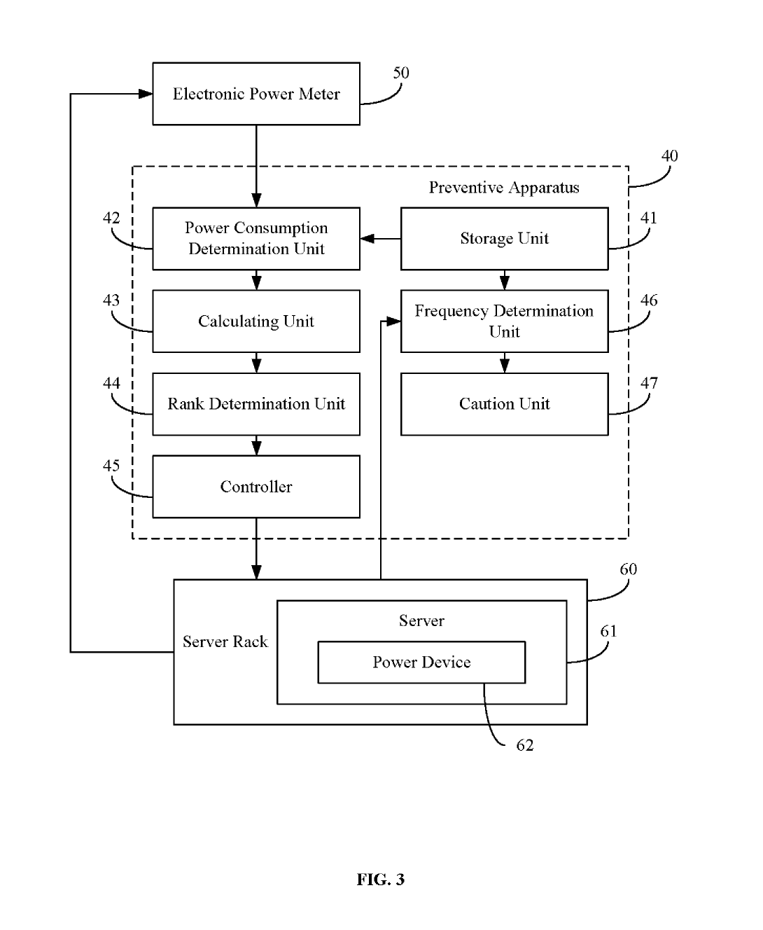

FIG. 3 illustrates a preventive apparatus 40 for protecting a server 61 according to another embodiment. The preventive apparatus 40 is electrically coupled to an electronic power meter 50 and a server rack 60. The electronic power meter 50 is electrically coupled to the server rack 60. The server 61 is accommodated in the server rack 60, and the server 61 can include a power device 62. The power device 62 consumes a lot of power when the server 61 is working, the power device 62 can be a CPU or a memory bank. The preventive apparatus 40 can include a storage unit 41, a power consumption determination unit 42, a calculating unit 43, a rank determination unit 44, a controller 45, a frequency determination unit 46 and a caution unit 47.

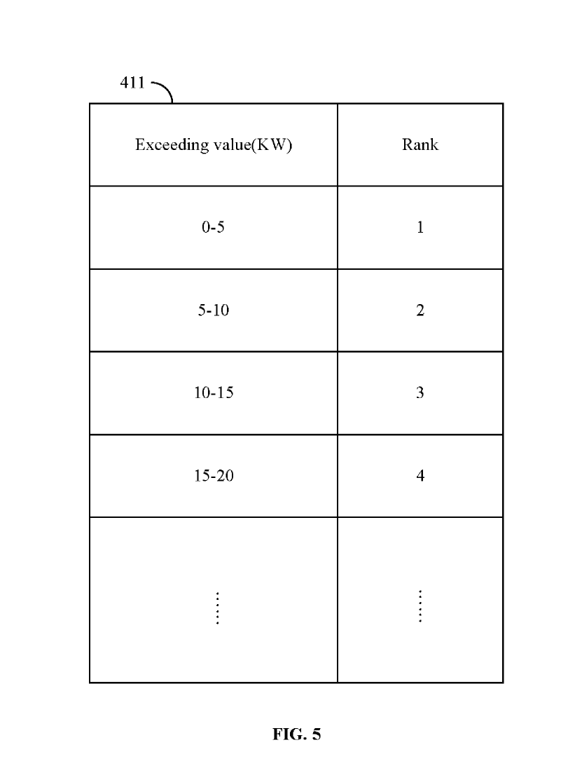

The storage unit 41 stores a preset power consumption value, a preset frequency value and a frequency-rank table 411 (shown in FIG. 5). The frequency-rank table 411 can map a relationship between any values exceeding the preset frequency value and the number of times that any such exceeding value needs to be decreased to achieve the preset operating frequency. An “exceeding value” is thus a value of the actual power consumption of the server 61 minus the preset power consumption value.

The power consumption determination unit 42 obtains power consumption data of the server 61 as it is detected by the electronic power meter 50. The power consumption determination unit 42 determines whether the obtained power consumption data of the server 61 has reached or exceeded the preset power consumption value stored in the storage unit 41.

The calculation unit 43 calculates the exceeding value when the power consumption data of the server 61 has reached or exceeded the preset power consumption value.

The rank determination unit 44 determines the number of times that the exceeding value should be decreased according to the exceeding value and the frequency-rank table 411.

The controller 45 sends a command to the server 61 to decrease the power consumption of the server 61 when the power consumption of the server 61 reaches or exceeds the preset power consumption value. In at least one embodiment, the controller 45 sends a command to the server 61 to decrease the operating frequency of the power device 62 of the server 61. The command sent from the controller 45 includes the number of times that the exceeding value should be decreased as determined by the rank determination unit 44.

The server 61 decreases the operating frequency of the power device 62 according to the command sent from the controller 45. In at least one embodiment, the server 61 decreases the operating frequency of the power device 62 by the number of decreases as determined and specified by the rank determination unit 44, each time decreasing the operating frequency of the power device 62 by one rank. For example, if the number of decreasing times is one, and 0.5 GHz constitutes a rank, and the current frequency of a CPU is 3.3 GHz, the frequency of a CPU will be decreased from 3.3 GHz to 2.8 GHz. If the number of decreasing times is two, the frequency of the CPU will be decreased once from 3.3 GHz to 2.8 GHz, and a second time from 2.8 GHz to 2.3 GHz. The power consumption of the server 61 decreases as the operating frequency of the power device 62 is decreased.

The frequency determination unit 46 obtains the operating frequency of the power device 62 after the server 61 has controlled the operating frequency of the power device 62 by decreasing it. The frequency determination unit 46 determines whether the operating frequency of the power device 62 is lower than the preset frequency value stored in the storage unit 41.

The caution unit 47 issues a caution message when the operating frequency of the power device 62, received by the frequency determination unit 46, has been lowered to equal or be less than the preset frequency value. In at least one embodiment, the caution unit 47 is a display panel, and the display panel shows a text message when the caution message is issued. In an alternative embodiment, the caution unit 47 can be a LED light or a loudspeaker. The LED light shines or the speaker makes audible sounds when the caution message is issued.

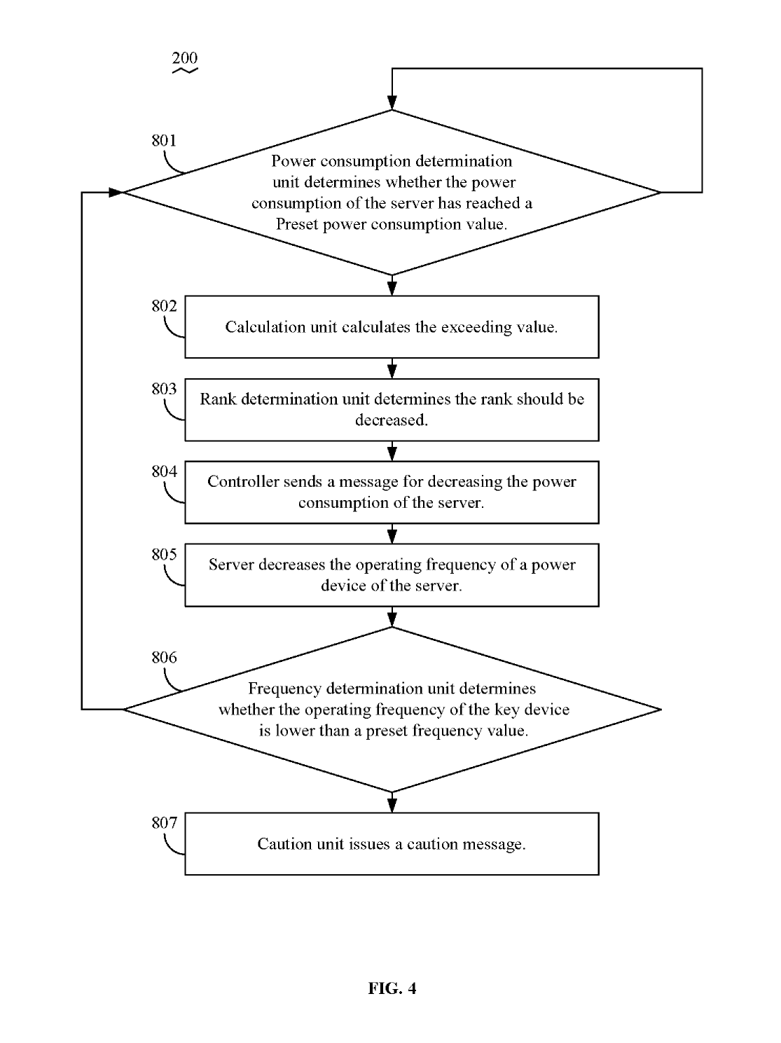

Referring to FIG. 4, a flowchart is presented in accordance with an example embodiment. The example method 200 is provided by way of example, as there are a variety of ways to carry out the method. The method 200 described below can be carried out using the configurations illustrated in FIG. 3 and various elements of these figures are referenced in explaining example method 200. Each block shown in FIG. 4 represents one or more processes, methods, or subroutines, carried out in the exemplary method 200. Additionally, the illustrated order of blocks is by example only and the order of the blocks can change. The exemplary method 200 can begin at block 801.

At block 801, a power consumption determination unit determines whether a power consumption value of a server has reached or exceeded a preset power consumption value stored in a storage unit. If yes, the process goes to block 802; otherwise, if the power consumption value of the server is lower than the preset power consumption value, the process remains in block 801.

At block 802, a calculation unit calculates an exceeding value of the power consumption of the server.

At block 803, a rank determination unit determines a number of times that a decreasing step should be conducted according to the exceeding value and a frequency-rank table stored in the storage unit.

At block 804, a controller sends a command to decrease the power consumption to the server, wherein the command includes the number of decreases.

At block 805, the server decreases the operating frequency of a power device of the server the required number of times, each time decreasing the operating frequency of the power device by one rank.

At block 806, a frequency determination unit obtains the operating frequency of the power device, and determines whether the operating frequency of the power device is equal to or lower than a preset frequency value stored in the storage unit. If yes, the process goes to block 807; otherwise, if the operating frequency of the power device is greater than the preset frequency value, the process goes to block 801.

At block 807, a caution unit issues a caution message.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular matters of shape, size and arrangement of the parts within the principles of the present disclosure, up to and including the full extent established by the broad general meaning of the terms used in the claims.

What is claimed is:

1. A preventive apparatus (10, 40) for protecting a server (31, 61), the preventive apparatus (10, 40) comprising:
a storage unit (11, 41) configured to store a preset power consumption value;
a power consumption determination unit (12, 42) configured to obtain a power consumption of the server (31, 61) and to determine whether the obtained power consumption of the server (31, 61) has reached or exceeded the preset power consumption value; and
a controller (13, 45) configured to send a command to the server (31, 61) for decreasing the power consumption of the server (31, 61) when the power consumption of the server (31, 61) reaches or exceeds the preset power consumption value, and to control the server (31, 61) to decrease a operating frequency of a power device (32, 62) of the server (31, 61).

2. The preventive apparatus (10, 40) of claim 1, further comprising:
a frequency determination unit (14, 46) configured to obtain the operating frequency of the power device (32, 62) and to determine whether the operating frequency of the power device (32, 62) is lower than a preset frequency value stored in the storage unit (11, 41); and
a caution unit (15, 47) configured to issue a caution message when the operating frequency of the power device (32, 62) is lower than the preset frequency value.

3. The preventive apparatus (10, 40) of claim 1, further comprising:
a calculating unit (43) configured to calculate an exceeding value when the power consumption of the server (31, 61) reaches or exceeds the preset power consumption value; and
a rank determination unit (44) configured to determine a decreasing times should be conducted according to the exceeding value and a frequency-rank table (411) stored in the storage unit (11, 41).

4. The preventive apparatus (10, 40) of claim 3, wherein the exceeding value is a value that the power consumption of the server (61) minus the preset power consumption value.

5. The preventive apparatus (10, 40) of claim 3, further comprising:
a frequency determination unit (14, 46) configured to obtain the operating frequency of the power device (32, 62) and to determine whether the operating frequency of the power device (32, 62) is lower than a preset frequency value stored in the storage unit (11, 41); and
a caution unit (15, 47) configured to issue a caution message when the operating frequency of the power device (32, 62) is lower than the preset frequency value.

6. The preventive apparatus (10, 40) of claim 5, wherein the caution unit (15, 47) is a display panel configured to show the caution message in a text message manner.

7. The preventive apparatus (10, 40) of claim 5, wherein the caution unit (15, 47) is a LED light configured to show the caution message in a light shining manner.

8. The preventive apparatus (10, 40) of claim 5, wherein the caution unit (15, 47) is a loudspeaker configured to show the caution message in a sound manner.

9. A preventive method for protecting a server, the preventive method comprising:
obtaining a power consumption value of the server and determining whether the power consumption value of the server has reached a preset power consumption value; and
sending a command to the server for decreasing the power consumption of the server when the power consumption value of the server has reached or exceeded the preset power consumption value, and to control the server to decrease the operating frequency of a power device of the server.

10. The preventive method of claim 9, further comprising:
obtaining the operating frequency of the power device and determining whether the operating frequency of the power device is lower than a preset frequency value; and
creating a caution message when the operating frequency of the power device is lower than the preset frequency value.

11. The preventive method of claim 9, further comprising:
calculating an exceeding value when the power consumption of the server has reached or exceeded the preset power consumption value; and
determining a decreasing times should be conducted according to the exceeding value and a frequency-rank table.

12. The preventive method of claim 10, further comprising:
obtaining the operating frequency of the power device and determining whether the operating frequency of the power device is lower than a preset frequency value; and
creating a caution message when the operating frequency of the power device is lower than the preset frequency value.
